(19) United States
(12) Patent Application Publication
(10) Pub. No.: US 2024/0291177 A1
(43) Pub. Date: Aug. 29, 2024

(54) TOUCH PROTECTION COVER, CONNECTION PART AND MODULE CONNECTOR

(71) Applicant: TE Connectivity Solutions GmbH, Schaffhausen (CH)

(72) Inventors: Jens HUBER, Bensheim (DE); Frank WITTROCK, Bensheim (DE)

(21) Appl. No.: 18/584,660

(22) Filed: Feb. 22, 2024

(30) Foreign Application Priority Data
Feb. 24, 2023 (DE) 102023104652.7

(51) Int. Cl. H01R 4/70; H01R 4/30

(52) U.S. Cl. CPC H01R 4/70; H01R 4/305

(57) ABSTRACT

An electrically insulating touch protection cover is provided for a connection part of an electrical module connector for electrically connecting two electrical modules, in particular two battery modules. The touch protection cover includes a protection housing and a screw guide element with an insertion opening. The protection housing is configured to at least sectionally surround an electrical conductor of the connection part. The insertion opening of the screw guide element is configured to at least sectionally receive a screw serving the fixation of the electrical conductor in a rotatable manner. The screw guide element is movable relative to the protection housing und monolithically connected with the protection housing.

### CROSS REFERENCE TO RELATED APPLICATIONS

This application claims the benefit of DE Application No. 102023104652.7 filed 24 Feb. 2023, the subject matter of which is herein incorporated by reference in its entirety.

### BACKGROUND OF THE INVENTION

The subject matter herein relates to an electrically insulating touch protection cover for a connection part of an electrical module connector for electrically connecting two electrical modules, in particular two battery modules. The battery modules may be battery modules for electric vehicles or energy technology systems. Further, the subject matter therein relates to a connection part with such a touch protection cover as well as a module connector with a connection part and a counterpart complementary thereto.

The relative position between the two electrical modules to be connected with the module connector is subject to tolerance-related fluctuations. These fluctuations prove to be problematic if, for example, the connection part and counterpart of the module connector are to be fixed through a screw connection.

Thus, there is a need to connect electrical modules without great effort despite positional tolerances.

### BRIEF DESCRIPTION OF THE INVENTION

In one embodiment, a module connector is provided which is easy and inexpensive to manufacture and with which even large positional tolerances can be compensated with little effort.

In an embodiment, a touch protection cover is provided including a protection housing and a screw guide element with an insertion opening. The protection housing is configured to at least sectionally surround an electrical conductor of the connection part. The insertion opening of the screw guide element is configured to at least sectionally receive, in a rotatable manner, a screw serving to fix the electrical conductor. The screw guide element is movable relative to the protection housing and is monolithically connected with the protection housing.

Advantageously, the touch protection cover can be installed on the connection part of the electrical module connector and, owing to the mobility of the screw guide element, allows a position tolerance to be compensated for when connecting the electrical modules. In other words, the position of a screw of the connection part received in the insertion opening can be adjusted with regard to its position to differing relative positions of the two to-be-connected electrical modules.

Due to the monolithic connection between the protection housing and the screw guide element, the number of separate components is reduced and the touch protection cover and module connector can be manufactured easily and cost-effectively. Handling is also simplified due to the low number of components.

In addition, the screw guide element is held in a predefined nominal position by means of the monolithic connection as long as no external force is applied. As a nominal position, a position suitable for a plurality of applications (e.g. center position) can be selected. This simplifies the installation process in terms of its complexity and time required, as fewer components have to be involved, which also do not “wobble around” loosely.

Consequently, the touch protection cover solves the object introductorily specified.

The above solution can even be further improved with the additional configurations explained below. The individual configurations are each advantageous independently of one another and can be combined with one another as desired.

According to one possible configuration, the touch protection cover can comprise a flexural hinge or flexure bearing, in particular a spring joint, which connects the screw guide element and the protection housing monolithically with each other and movably to each other. By means of the flexure bearing, the monolithic connection between the protection housing and the screw guide element can be created in a simple manner.

According to a further possible configuration, the screw guide element can be arranged in an opening of the protection housing, which results in a certain space saving. Furthermore, the flexure bearing can be arranged in the opening of the protection housing, in the plane of which the screw guide element is then guided movably by the flexure bearing relative to the protection housing. In particular, the screw guide element can be floatingly mounted in the opening of the protection housing.

The opening of the protection housing runs from an outside of the protection housing into an interior of the protection housing. Inside the protection housing, the electrical conductor surrounded by the protection housing can extend, for example, in the form of a busbar or a current strip. Preferably, the insertion opening of the screw guide element and the opening of the protection housing are arranged coaxially.

The screw guide element can be spaced apart from the protection housing by the opening. In particular, the screw guide element can be separated from the protection housing by a gap, wherein the gap is part of the opening. The gap can, for example, circumferentially surround the screw guide element as an annular gap and be bridged by the flexure bearing. The gap thus provides freedom of movement for the screw guide element. Accordingly, the gap narrows at least sectionally and widens elsewhere when the screw guide element is moved relative to the protection housing.

Preferably, the size of the gap is limited in each position of the screw guide element such that touching the electrical conductor running inside the protection housing by a user's finger is prevented. The user's finger can, for example, be simulated by a test finger in accordance with the usual standards, for example DIN EN 60529:2000, which specifies a length of 80 mm and a diameter of 12 mm for the test finger. Other relevant standards can be: VDE 0470 Part 2, IEC/EN 61032, VDE 0470 Part 1 or IEC/EN 60529, IEC/EN 60950, IEC 61010, IEC/EN 60335, IEC/EN 60745-1, IEC/EN 60034-5 and IEC/EN 60065.

A configuration that is easy to manufacture results if the flexure bearing comprises at least one deformable material bridge that extends from the protection housing to the screw guide element. The at least one material bridge can thereby bridge the gap. In addition to the shape of the gap, the configuration of the material bridge also defines the radius of movement of the screw guide element. The screw guide element can be movable relative to the protection housing with deformation of the at least one material bridge.

The at least one material bridge can comprise two joints. The respective joint connects two adjacent areas to each other in an articulated manner. These two adjacent areas are preferably pivotable about the joint, in particular pivotable in one plane. For this purpose, the flexural rigidity at the respective joint is lower than at the areas directly surrounding the joint. In other words, the two adjacent areas are more rigid than the respective joint.

The pivoting planes of the two joints are preferably parallel to each other. In addition, the pivoting planes of the two joints are optionally parallel to the aforementioned plane of the opening of the protection housing. Furthermore, the pivoting planes of the two joints can be perpendicular to the insertion opening.

The two joints can be arranged at any point in the at least one material bridge. For example, one joint can be directly adjacent to the protection housing and/or the other joint can be directly adjacent to the screw guide element. This allows the material bridge to be connected to the screw guide element with one joint and to the protection housing with the other joint.

Alternatively, the two joints can be arranged spaced apart from both the protection housing as well as the screw guide element. In this case, one joint is preferably within a distance of ⅓ of the length of the material bridge from the protection housing and/or the other joint is within a distance of ⅓ of the length of the material bridge from the screw guide element.

The joints can each be formed by a bent or kinked section of the material bridge. According to a cost-effective configuration of the touch protection cover, the joints can each be configured as a film hinge.

In order to achieve improved stability, the flexure bearing can have at least two material bridges, each of which extends from the protection housing to the screw guide element. Accordingly, at least four joints are provided in the at least two material bridges. Preferably, the at least two material bridges engage with the screw guide element at diametrically opposite points. In this case, the at least two material bridges each extend at least sectionally along a circumferential direction of the insertion opening. For example, the at least two material bridges each run approximately tangentially to the insertion opening, at least sectionally. The at least two material bridges can each have at least one bend. In addition, the at least two material bridges can each have a shorter section and a longer section, which are separated from each other by the at least one bend. The longer section is based, for example, on the protection housing and the shorter section on the screw guide element. The longer sections can extend parallel to a tangent of the insertion opening, while the shorter sections run radially to the insertion opening. In particular, the at least two material bridges can each be configured to be L-shaped, J-shaped or S-shaped. This increases the mobility of the screw guide element compared to straight, radially extending, spoke-like material bridges.

For applications in which the screw position only needs to be adjusted along a single direction, it is advisable to limit the mobility of the screw guide element to what is necessary. For this purpose, the screw guide element can be guided movably along a compensation direction by the flexure bearing with respect to the protection housing. Preferably, the screw guide element is guided essentially in a straight line relative to the protection housing. In this case, the compensation direction is preferably perpendicular to the screw axis and corresponds to the direction along which the screw position is to be adjusted. In the embodiment with at least two material bridges, the mobility of the screw guide element can be limited to the compensation direction, in that the at least two material bridges are arranged point-symmetrically with respect to the screw guide element. In particular, the at least two material bridges can hold the screw guide element in a bifilar manner.

In particular, the insertion opening of the screw guide element can be configured to at least partially receive a screw head of the screw in a rotatable manner. Furthermore, the screw guide element can comprise a sleeve-shaped section or collar that is configured to guide the screw head linearly. In this case, a plane of mobility of the screw guide element is preferably perpendicular to the screw axis and perpendicular to the guide direction within the sleeve-shaped section or collar. Optionally, the screw guide element can have at least one locking arm that is configured to engage behind the screw head. Preferably, the at least one locking arm is flexible and arranged in the sleeve-shaped section or collar. This prevents the screw from being lost.

In addition to the screw guide element, the touch protection cover can comprise a guide element that is spaced apart from the screw guide element, monolithically connected to the protection housing and movable relative to the protection housing. In this case, the guide element is preferably spaced apart from the screw guide element in an axial direction of the insertion opening and has a push-through opening arranged flush with the insertion opening for pushing through a screw shaft of the screw. For a screw, the screw head of which is received in the insertion opening and the screw shaft of which is passed through the push-through opening, the screw guide element and guide element enable parallel guidance. This prevents the screw from tilting or canting.

A further flexure bearing can connect the guide element and the protection housing. In this case, the further flexure bearing can have the same configuration as the flexure bearing on the screw guide element. In particular, the further flexure bearing can have at least one material bridge that extends from the protection housing to the guide element. The at least one material bridge of the further flexure bearing can be configured in the same way as the at least one material bridge that connects the screw guide element and the protection housing.

Between the screw guide element and the guide element, the electrical conductor of the connection part can extend. In other words, the screw guide element and the guide element are arranged on opposite sides of the electrical conductor. In the event that the connection part has an electrically conductive current bridge, as is often the case with electrical module connectors, the guide element can be configured to at least partially receive the current bridge. In particular, the guide element can be configured to hold the current bridge captively. Alternatively, the current bridge can be located on the mating part of the connection part so that the connection part itself does not have a current bridge to be held captively.

As already mentioned, it is provided that the electrical conductor of the connection part extends inside the protection housing. In order to be able to easily attach the electrical conductor there, it is advisable to configure the protection housing in two parts consisting of two housing halves that can be joined to each other. In this case, the screw guide element and the guide element are preferably connected to different housing halves.

The object introductorily specified is solved by the connection part if the connection part comprises a touch protection cover according to one of the above configurations, an electrical conductor surrounded by the protection housing of the touch protection cover, and a screw, the screw head of which is received in the screw guide element of the touch protection cover. In this context, the connection part benefits from the advantages and functions of the touch protection cover already explained. In particular, the comparatively small number of components simplifies the manufacture, assembly and installation of the connection part.

According to a possible configuration of the connection part, an oblong hole can be located in the extension of the insertion opening of the screw guide element. For example, one end of the electrical conductor can have the oblong hole. The oblong hole is preferably configured to receive the screw shaft of the screw or a threaded bolt. The oblong hole can thus advantageously serve as a linear guide for the screw. Accordingly, the longitudinal direction of the oblong hole can be aligned along the aforementioned compensation direction. In other words, the oblong hole extends in the compensation direction.

A module connector also solves the object introductorily specified if the module connector comprises a connection part according to one of the above embodiments and a counterpart to the connection part, wherein the counterpart comprises a threaded sleeve configured complementarily to the screw of the connection part. Owing to the mobility of the screw guide element, the screw can be aligned so as to be axially flush with the threaded sleeve. Due to the low number of components, in particular of the touch protection cover, the module connector can be assembled with little effort and is also easy to maintain later.

Any references to norms and standards (e.g. DIN/IEC/EN standards) in this application refer to the version of the relevant norm or standard valid at the time of filing.

In the following, the invention is explained by means of exemplary configurations with reference to the drawings. The respective configurations merely reflect a possible combination of features. Individual features of a configuration can be omitted in accordance with the above explanations if the technical effect associated with the respective feature is not important in a particular application. Conversely, a feature of the configuration described can be added if the technical effect associated with this feature is important for a particular application of the configuration.

In the drawings, the same reference signs are used for features that correspond to each other in terms of function and/or structure.

### BRIEF DESCRIPTION OF THE DRAWINGS

FIG. 1 a schematic illustration of the touch protection cover according to an exemplary embodiment as a top view;

FIG. 2 a schematic perspective sectional illustration of the touch protection cover from FIG. 1 in another view;

FIG. 3 a schematic perspective exploded illustration of a connection part according to an exemplary embodiment;

FIG. 4 a schematic perspective exploded illustration of the connection part from FIG. 3;

FIG. 5 a schematic perspective illustration of a connection part according to a further exemplary embodiment; and

FIG. 6 a schematic perspective exploded illustration of a module connector according to an exemplary embodiment.

### DETAILED DESCRIPTION OF THE INVENTION

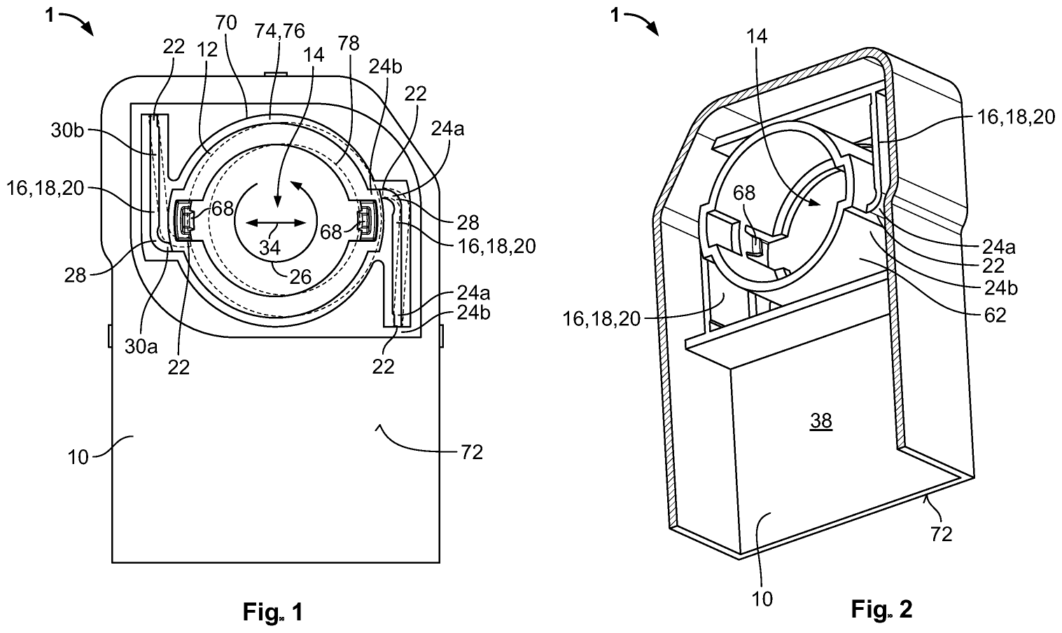

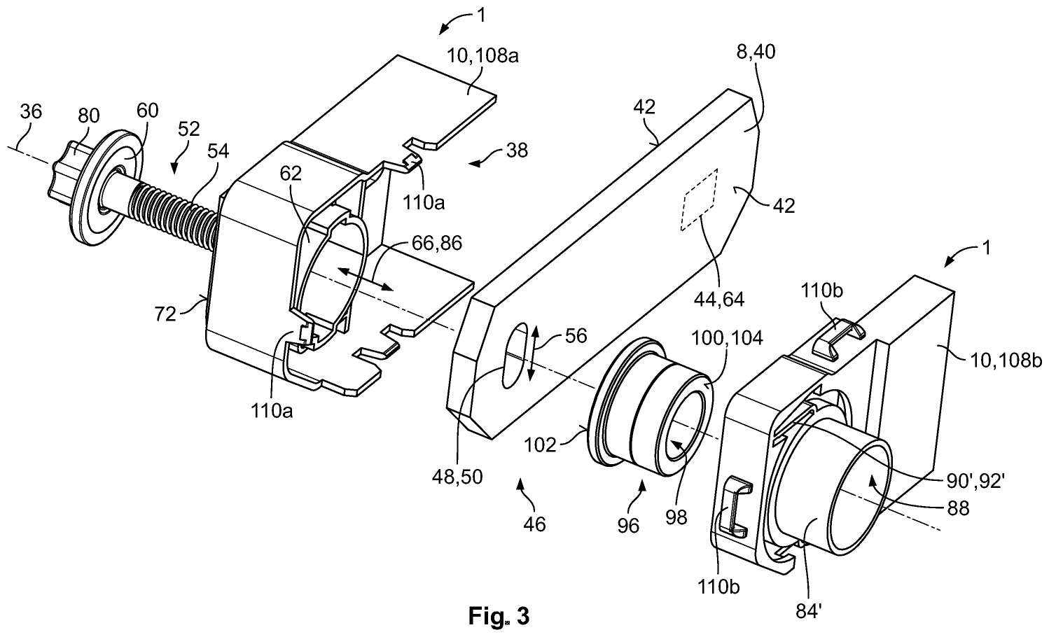

In the following, a touch protection cover 1 is described according to an exemplary embodiment with reference to FIGS. 1 and 2. Furthermore, a connection part 2 of a module connector 4 and the module connector 4 itself are each described according to an exemplary embodiment with reference to FIGS. 3 to 6.

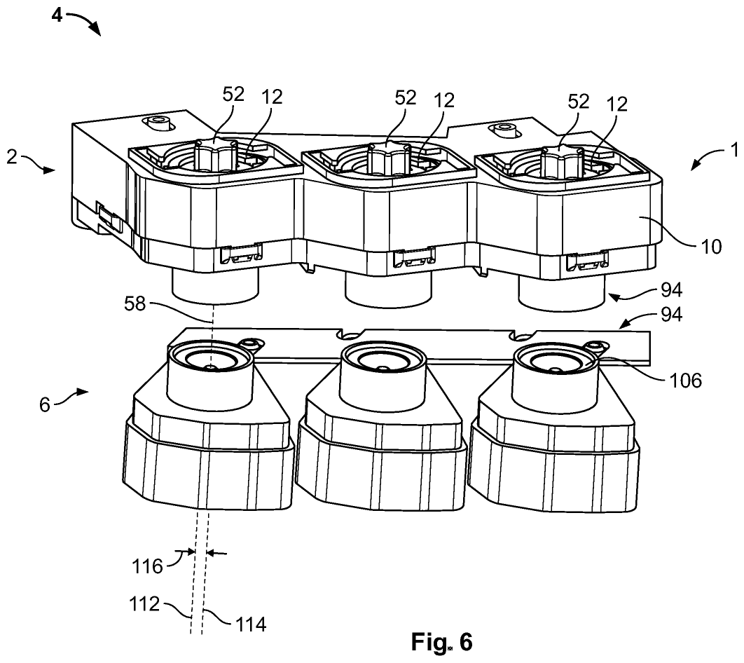

FIG. 1 shows the touch protection cover 1 in a top view. FIG. 2 shows a perspective illustration of the touch protection cover 1 in a partial sectional view from below. The touch protection cover 1 is made of an electrically insulating material, for example plastic, and is provided to be installed on the connection part 2 of the electrical module connector 4. The electrical module connector 4 serves to electrically connect two electrical modules (not shown), in particular two battery modules (not shown) in high-voltage applications, by connecting the connection part 2 to a complementarily configured counterpart 6 (see FIG. 6) to the connection part 2. In this case, an electrical conductor 8 (see FIG. 3) of the connection part 2 is brought into electrical contact with an electrical conductor 8 (see FIG. 6) of the counterpart 6.

As can be seen from FIG. 1, the touch protection cover 1 comprises a protection housing 10 and a screw guide element 12 with an insertion opening 14. The screw guide element 12 is movable relative to the protective housing 10 for the purpose of position adjustment and at the same time is monolithically connected to the protective housing 10. For this purpose, the contact protection cover 1 comprises a flexure bearing 16, in particular a spring joint 18, which connects the screw guide element 12 and the protection housing 10 monolithically and movably to one another.

The flexure bearing 16 may comprise at least one deformable material bridge 20 extending from the protection housing 10 to the screw guide element 12. The at least one material bridge 20 can comprise two joints 22. The respective joint 22 connects two adjacent areas 24a, 24b to each other in a hinged manner. These two adjacent areas 24a, 24b are preferably pivotable about the joint 22, in particular pivotable in one plane. For this purpose, the flexural rigidity at the respective joint 22 is lower than at the areas 24a, 24b directly surrounding the joint 22. In other words, the two adjacent areas 24a, 24b are more rigid than the respective joint 22.

The two joints 22 can be arranged at any position in the at least one material bridge 20. In FIG. 1, one joint 22 each is arranged directly on the protection housing 10 and the other joint 22 is arranged directly adjacent to the screw guide element 12. Alternatively, the two joints can be arranged spaced apart from both the protection housing and the screw guide element. In this case, one joint is preferably within a distance of ⅓ of the length of the material bridge from the protection housing and/or the other joint is within a distance of ⅓ of the length of the material bridge from the screw guide element.

The flexure bearing 16 shown in FIG. 1 has two material bridges 20, each of which extends from the protection housing 10 to the screw guide element 12. Preferably, the two material bridges 20 engage on the screw guide element 12 at diametrically opposite points. Furthermore, the two material bridges 20 each extend at least sectionally along a circumferential direction 26 of the insertion opening 14. In the exemplary embodiment shown, the two material bridges 20 each extend at least sectionally approximately tangentially to the insertion opening 14.

The two material bridges 20 can each comprise at least one bend 28. In addition, the two material bridges 20 can each comprise a shorter section 30a and a longer section 30b, which are separated from one another by the at least one bend 28. For example, the longer section 30b is based on the protection housing 10 and the shorter section 30a is based on the screw guide element 12. The longer sections 30b can extend parallel to each other, while the shorter sections 30a extend radially to the insertion opening 14. In particular, the two material bridges 20 can each be configured to be L-shaped, J-shaped or S-shaped.

In the exemplary embodiment shown in FIG. 1, the two material bridges 20 are arranged point-symmetrically with respect to the screw guide element 12. Thus, the screw guide element 12 is guided by the flexure bearing 16 so as to be movable relative to the protection housing 10 along a compensation direction 34. Preferably, the screw guide element 12 is guided essentially in a straight line relative to the protection housing 10. In this case, the compensation direction 34 is preferably perpendicular to the screw axis 36 and corresponds to a direction along which the aforementioned position adjustment is to take place.

The protection housing 10 is configured to at least partially surround the electrical conductor 8 of the connection part 2. For this purpose, the protection housing 10 provides space for the electrical conductor 8 in its interior 38. As can be seen from FIG. 3, the electrical conductor 8 can be a busbar 40 made of copper, aluminum or an alloy containing copper or aluminum. Alternatively, a current strip (not shown) made of braided metal wire can also be used.

The busbar 40 has at least one flat side 42, which defines a busbar plane 44. In this context, the screw guide element 12 is displaceable parallel to the busbar plane 44. Preferably, the busbar 40 has two flat sides 42 that are parallel to each other. When connecting the electrical modules, the flat sides 42 of the busbar 40 are aligned in the direction towards and away from the electrical modules. In the embodiment shown, the busbar 40 has a rectangular cable cross-section. Other conductor cross-sections, for example square, polygonal, circular, oval or U-shaped conductor cross-sections are also possible.

In the installed state, at least one end 46 of the electrical conductor 8 extends through the interior 38 of the protection housing 10. At this end 46, the electrical conductor 8 can comprise an oblong hole 48. The oblong hole 48 connects both flat sides 42 of the busbar 40 with each other. Thus, the oblong hole 48 fulfills the function of a screw opening 50 for a screw 52 of the connection part 2 serving to fasten the electrical conductor 8 (see FIG. 3). For this purpose, the oblong hole 48 is configured to receive a screw shaft 54 of the screw 52. Furthermore, the oblong hole 48 serves as a linear guide for the screw 52. The longitudinal direction 56 of the oblong hole 48 is aligned parallel to the aforementioned compensation direction 34. In other words, the oblong hole 48 extends in the compensation direction 34.

The screw 52 forms a screw connection with a threaded sleeve (not shown) of the counterpart 6 of the module connector 4 that is configured complementarily to it. In order that the screw connection can also be created despite tolerance-related fluctuations in the relative position 58 between connection part 2 and counterpart 6, the screw 52 is held movably by the touch protection cover 1. This task is assumed by the screw guide element 12, which is configured to at least partially receive the screw 52 in the insertion opening 14 in a rotatable manner. In particular, the insertion opening 14 can be configured to rotatably receive a screw head 60 of the screw 52.

For this purpose, the screw guide element 12 can comprise a sleeve-shaped section 62 configured to linearly guide the received screw head 60 along the insertion opening 14. In this case, a plane 64 of mobility of the screw guide element 12 is preferably perpendicular to the screw axis 36 and perpendicular to the guide direction 66 within the sleeve-shaped section 62. Optionally, the screw guide element 12 can comprise locking arms 68 which are configured to engage behind the received screw head 60. Preferably, the locking arms 68 are flexible and arranged in the sleeve-shaped section 62.

As can also be seen from FIG. 1, the screw guide element 12 and the flexure bearing 16 can be arranged in an opening 70 of the protection housing 10. In this case, the insertion opening 14 of the screw guide element 12 and the opening 70 of the protection housing 10 are arranged coaxially or at least concentrically. In the plane of the opening 70, the screw guide element 12 is thus guided movably relative to the protection housing 10 by the flexure bearing 16. In particular, the screw guide element 12 can be floatingly mounted in the opening 70.

The opening 70 leads from an outside 72 of the protection housing 10 into the interior 38 of the protection housing 10. The screw head 60 received in the screw guide element 12 is accessible from the outside through this opening 70, so that the screw 52 can be tightened or loosened as required.

The screw guide element 12 may be spaced apart from the protection housing 10 by the opening 70. In particular, the screw guide element 12 can be separated from the protection housing 10 by a gap 74, wherein the gap 74 is part of the opening 70. The gap 74 can, for example, surround the screw guide element 12 circumferentially as an annular gap 76 and be bridged by the flexure bearing 16. The gap 74 can occur due to the manufacturing process, however, it also provides a certain amount of freedom of movement for the screw guide element 12. As indicated by dashed lines 78 in FIG. 1, the gap 74 narrows at least sectionally and widens elsewhere when the screw guide element 12 is moved relative to the protection housing 10.

However, the size of the gap 74 is limited in each position of the screw guide element 12 such that touching of the electrical conductor 8 extending in the interior 38 of the protection housing 10 by a finger (not shown) of a user is prevented. The user's finger can, for example, be simulated by a test finger (not shown) according to the usual standards, for example according to DIN EN 60529:2000, which specifies a length of 80 mm and a diameter of 12 mm for the test finger. Other relevant standards can be: VDE 0470 Part 2, IEC/EN 61032, VDE 0470 Part 1 or IEC/EN 60529, IEC/EN 60950, IEC 61010, IEC/EN 60335, IEC/EN 60745-1, IEC/EN 60034-5 and IEC/EN 60065.

A cap 80 molded onto the screw head 60 of the screw 52 interacts with the touch protection cover 1. Furthermore, a cap 82 can also be placed or molded onto a tip of the screw shaft 54 facing away from the screw head 60. This, in interaction with the touch protection cover 1, ensures that no gaps are created that would allow the user's finger to touch the current-carrying components.

In FIG. 3 it can be seen that, in addition to the screw guide element 12, the touch protection cover 1 can comprise a guide element 84′ that is spaced apart from the screw guide element 12, is also monolithically connected to the protection housing 10, and is movable relative to the protection housing 10. In this context, the guide element 84′ is preferably spaced apart from the screw guide element 12 in an axial direction 86 of the insertion opening 14 and comprises a push-through opening 88 arranged so as to be flush with the insertion opening 14 for pushing through the screw shaft 54 of the screw 52. For a screw 52, the screw head 60 of which is received in the insertion opening 14 and the screw shaft 54 of which is passed through the push-through opening 88, screw guide element 12 and guide element 84′ enable parallel guidance. This prevents the screw 52 from tilting or canting.

A further flexure bearing 90′ can connect the guide element 84′ and the protection housing 10. In this context, the further flexure bearing 90′ can have the same configuration as the flexure bearing 16 on the screw guide element 12. In particular, the further flexure bearing 90′ can have at least one material bridge 92′ that extends from the protection housing 10 to the guide element 84′. The at least one material bridge 92′ of the further flexure bearing 90′ can be configured in the same way as the at least one material bridge 20, which connects the screw guide element 12 and the protection housing 10.

The electrical conductor 8 of the connection part 2 can extend between the screw guide element 12 and the guide element 84′. In other words, screw guide element 12 and guide element 84′ are arranged on opposite sides of electrical conductor 8. The guide element 84′ forms a mating face 94, which is configured complementarily to a mating face 94 of the counterpart 6 and can be plugged together with the latter (see FIG. 6).

In particular, if the electrical conductor 8 is made of aluminum or aluminum alloy, the connection part 2 has a current bridge 96 made of copper or copper alloy in order to reduce the electrical resistance. This can be seen in FIG. 3. The current bridge 96 has a central opening 98, which preferably extends parallel and coaxially to the push-through opening 88 of the guide element 90′. The screw shaft 54 fits through the central opening 98.

The current bridge 96 is configured in the shape of a hollow cylinder with a circular base surface 100 and a circular end surface 102. At the base surface 100, the current bridge 96 forms a pre-defined interface 104 to a mating contact 106 of the counterpart 6 (see FIG. 6). With its end surface 102, the current bridge 96 abuts against one flat side 42 of the busbar 40 opposite the screw guide element 12. In order to increase the contact surface between the current bridge 96 and the busbar 40, the current bridge 96 has a widened end surface 102.

The guide element 84′ is configured accordingly to at least partially receive the current bridge 96. In particular, the guide element 84′ can be configured to hold the current bridge 96 captively. Alternatively, the current bridge can be seated on the counterpart of the connection part, so that the connection part itself does not have a current bridge to be held captively.

In order to be able to install the electrical conductor 8 in the protection housing 10 in a simple manner, the protection housing 10 is configured in two parts consisting of two housing halves 108a, 108b that can be joined together. The housing halves 108a, 108b are provided with mutually complementary latching elements 110a, 110b. Alternatively or additionally, the housing halves 108a, 108b may be glued, welded, pressed or otherwise attached to each other. The housing halves 108a, 108b are assembled and closed around the electrical conductor 8, the current bridge 96 and the screw 52. In this context, the screw guide element 12 and the guide element 84′ are connected to different housing halves 108a, 108b.

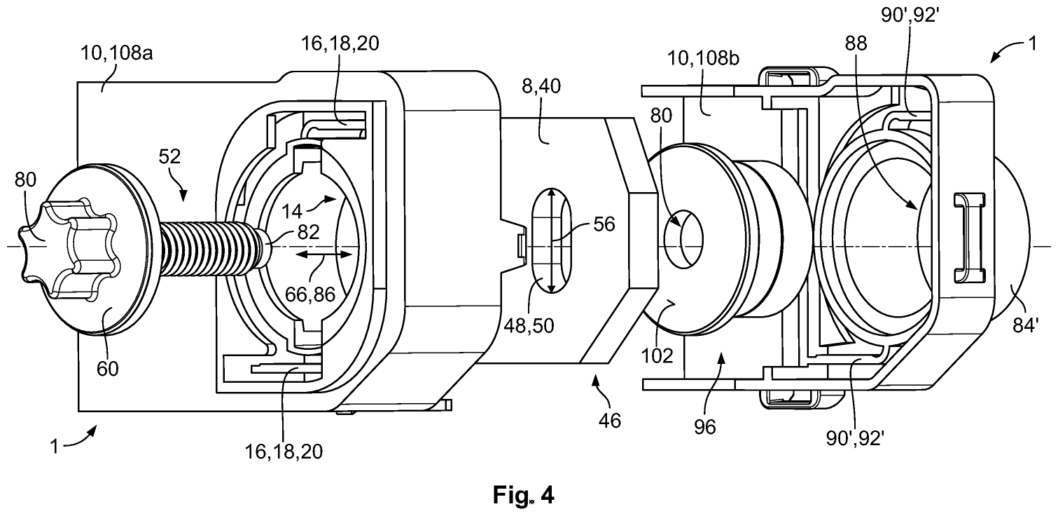

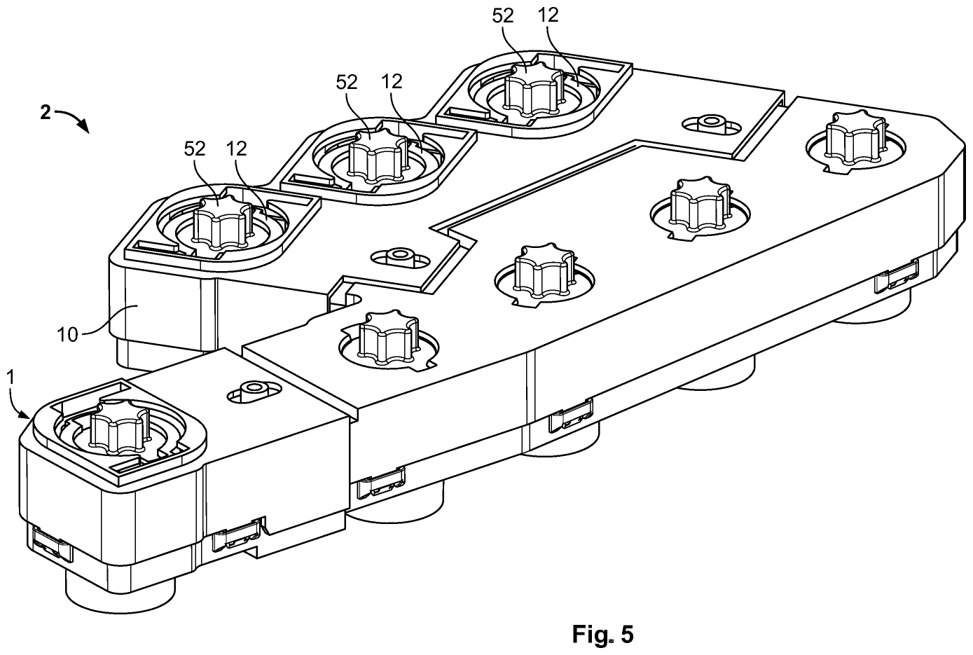

In the connection part 2 in FIGS. 3 and 4, the screw head 60 is received in the screw guide element 12 and the current bridge 96 in the guide element 84′. FIG. 5 shows that the connection part 2 can also be configured for simultaneous connection of several electrical modules. For this purpose, the connection part 2 comprises several electrical conductors (not shown), several current bridges (not shown) and a plurality of screws 52. For each or a plurality of the screws 52, the touch protection cover 1 can have separate screw guide elements 12, which are movable relative to the protection housing 10 and at the same time monolithically connected to the protection housing 10.

FIG. 6 shows an exemplary embodiment of the electrical module connector 4 for connecting several electrical modules (not shown) in pairs. The module connector 4 has a corresponding number of connection parts 2 and fixed counterparts 6. The connection parts 2 have a common protection housing 10. In the event that the installation positions 112 of the counterparts 6 shown deviate from a predetermined target position 114, this position tolerance 116 can be compensated for by displacing the screws 52 together with the associated current bridges 96, the screw guide elements 12 and the guide elements 84′ in accordance with the actual installation positions.

The screws 52 and screw guide elements 12 can be rotated and displaced until the screws 52 are completely screwed onto the respective threaded sleeves. After tightening, the resulting frictional forces and positive locking prevent rotation and displacement.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrically insulating touch protection cover for a connection part of an electrical module connector, wherein the touch protection cover comprises
a protection housing configured to at least sectionally surround an electrical conductor of the connection part;
a screw guide element with an insertion opening which is configured to at least sectionally receive, in a rotatable manner, a screw serving the fixation of the electrical conductor;
wherein the screw guide element is movable relative to the protection housing and is monolithically connected thereto.

2. Touch protection cover according to claim 1, comprising a flexure bearing which connects the screw guide element and the protection housing monolithically and movably to each other.

3. Touch protection cover according to claim 2, wherein the screw guide element and the flexure bearing are arranged in an opening of the protection housing, in a plane of which the screw guide element is movably guided by the flexure bearing relative to the protection housing.

4. Touch protection cover according to claim 2, wherein the screw guide element is separated from the protection housing by a gap which is bridged by the flexure bearing.

5. Touch protection cover according to claim 2, wherein the flexure bearing comprises at least one deformable material bridge extending from the protection housing to the screw guide element.

6. Touch protection cover according to claim 5, wherein the at least one material bridge has two joints.

7. Touch protection cover according to claim 6, wherein the joints are each configured as a film hinge.

8. Touch protection cover according to claim 2, wherein the screw guide element is guided by the flexure bearing movably with respect to the protection housing along a compensation direction.

9. Touch protection cover according to claim 1, wherein the touch protection cover comprises a guide element which is spaced apart from the screw guide element, is monolithically connected to the protection housing, has a push-through opening arranged so as to be flush with the insertion opening for pushing through a screw shaft of the screw and is movable relative to the protection housing.

10. Touch protection cover according to claim 9, wherein the guide element is configured to at least partially receive an electrically conductive current bridge of the connection part.

11. Touch protection cover according to claim 9, wherein the protection housing is configured from two housing halves which can be joined together and wherein the screw guide element and the guide element are connected to different housing halves.

12. Connection part comprising:
a touch protection cover including a protection housing and a screw guide element with an insertion opening, wherein the screw guide element is movable relative to the protection housing and is monolithically connected thereto;
an electrical conductor, wherein the protection housing is configured to at least sectionally surround the electrical conductor; and
a screw serving as a fixation of the electrical conductor, the screw having a screw head received in the screw guide element of the touch protection cover, wherein the insertion opening is configured to at least sectionally receive, in a rotatable manner, the screw.

13. Connection part according to claim 12, wherein the connection part has an oblong hole in the extension of the insertion opening, a longitudinal direction of which is aligned along the compensation direction.

14. Connection part according to claim 13, wherein one end of the electrical conductor has the oblong hole.

15. Connection part according to claim 12, wherein the touch protection cover includes a flexure bearing which connects the screw guide element and the protection housing monolithically and movably to each other.

16. Connection part according to claim 15, wherein the flexure bearing comprises at least one deformable material bridge extending from the protection housing to the screw guide element.

17. Connection part according to claim 12, wherein the touch protection cover includes a guide element which is spaced apart from the screw guide element, is monolithically connected to the protection housing, has a push-through opening arranged so as to be flush with the insertion opening for pushing through a screw shaft of the screw and is movable relative to the protection housing.

18. Module connector comprising:
a connection part including an electrical conductor and a screw serving as a fixation of the electrical conductor, the connection part including a protection housing configured to at least sectionally surround the electrical conductor and a screw guide element with an insertion opening which is configured to at least sectionally receive, in a rotatable manner, the screw, the screw having a screw head received in the screw guide element of the touch protection cover, wherein the screw guide element is movable relative to the protection housing and is monolithically connected thereto; and
a counterpart to the connection part, wherein the counterpart comprises a threaded sleeve configured complementarily to the screw of the connection part.

19. Module connector according to claim 18, wherein the touch protection cover includes a flexure bearing which connects the screw guide element and the protection housing monolithically and movably to each other, the flexure bearing including at least one deformable material bridge extending from the protection housing to the screw guide element.

20. Module connector according to claim 18, wherein the touch protection cover includes a guide element which is spaced apart from the screw guide element, is monolithically connected to the protection housing, has a push-through opening arranged so as to be flush with the insertion opening for pushing through a screw shaft of the screw and is movable relative to the protection housing.
